(19) United States
(12) Patent Application Publication
(10) Pub. No.: US 2002/0160844 A1
(43) Pub. Date: Oct. 31, 2002

(54) Process for producing rotationally symmetrical components

(75) Inventors: Jochen Ginsberg, Siegen (DE); Thomas Muhr, Attendorn (DE)

Correspondence Address: NIXON PEABODY, LLP, 8180 GREENSBORO DRIVE, SUITE 800, MCLEAN, VA, 22102, US

(73) Assignee: Muhr und Bender, Attendorn (DE)

(21) Appl. No.: 10/131,138

(22) Filed: Apr. 25, 2002

(30) Foreign Application Priority Data
Apr. 25, 2001 (DE) 101 20 392.6

(51) Int. Cl. F16C 3/00

(52) U.S. Cl. 464/179; 29/525; 138/177

(57) ABSTRACT

A process for producing a hollow monoblock shaft from a pipe, the pipe initially having a constant diameter and a constant wall thickness, and the monoblock component including at least one area of its length being of a smaller outside diameter and a greater wall thickness than the constant diameter and constant wall thickness of the pipe. The process can be carried out simply and economically by the following process steps:

selecting a pipe with a wall thickness which corresponds to the smallest wall thickness of the finished component,

partial heating of at least one area of the pipe,

axial upsetting the heated area of the pipe and

radial forging the heated area of the pipe.

### BACKGROUND OF THE INVENTION

1. Field of the Invention

The invention relates to a process for producing rotationally symmetrical components from a pipe, especially hollow monoblockk shafts, the pipe initially having a constant outside diameter and a constant wall thickness, and the rotationally symmetrical component having at least over one area of its entire length an outside diameter which deviates from the constant outside diameter, especially as a smaller outside diameter, and/or a wall thickness which deviates from the constant wall thickness, especially as a greater wall thickness. In addition, the invention relates to a rotationally symmetrical component.

2. Description of Related Art

Rotationally symmetrical components which have different outside diameters and different wall thicknesses over their entire length are used especially in motor vehicles as drive shafts, camshafts, intermediate shafts or gear shafts. Under the aspect of “weight reduction” which is generally becoming more and more important, shafts produced from pipes, so-called hollow shafts, have been used for some time instead of shafts produced from solid bars. There are basically two different types of pipes each of which differ in their production process. Pipes, especially steel pipes, are produced either in a seamless version, i.e., from a solid material without a lengthwise seam, or in a welded version, i.e. from bent sheet metal or steel strip with a lengthwise seam. For rotating components generally welded pipes are used since seamless pipes require concentricity that is not always reliably ensured. In addition, production of seamless pipes is generally more expensive than production of welded pipes.

In order to produce the aforementioned rotationally symmetrical components with different outside diameters and wall thicknesses, at least theoretically there is the possibility of joining several pipes, each having a constant outside diameter and constant wall thickness, into a composite pipe with the desired outside diameter and wall thickness variation. These pipes composed of several individual pipes however generally do not meet the high mechanical requirements imposed on shafts in operation.

Therefore in the prior art, especially in motor vehicles, only monoblock shafts are used, i.e., those shafts which are made from a single piece, in this case from a single pipe. The shaft is generally produced from the pipe using the so-called rotary swaging process at room temperature. Generally, it is desirable that the shaft in its middle area have a wall thickness as small as possible and in one or both end areas a smaller outside diameter and a much greater wall thickness.

In this shaft construction the wall thickness which can be achieved in the end area by the rotary swaging process cannot be arbitrarily increased, but depends on the outside diameter and the wall thickness of the original pipe, and on the outside diameter of the end area of the shaft (material preservation or constant volume). If the end area is to have an especially large wall thickness, it is necessary for the initial material, i.e. the original pipe, to have a large enough wall thickness or a correspondingly large outside diameter. This can then lead to the wall thickness and/or the outside diameter of the original pipe having to be larger such that the wall thickness or outside diameter of the finished shaft in the middle area is larger than desired. As a result, the pipe not only needs the end areas to be worked by rotary swaging, but, in addition, the middle area must be reduced by sinking both in its outside diameter and also in its wall thickness.

Another problem often arises due to the fact that welded pipes cannot be produced with just any wall thickness or with just any ratio of wall thickness to outside diameter. Here the maximum ratio of wall thickness to outside diameter is roughly 1/7. If the pipe is to have an even greater wall thickness or a smaller outside diameter with the same wall thickness, this can no longer be achieved by simple bending of sheet metal or steel strip and subsequent welding of the pipe. In this case, first a pipe with a larger outside diameter and a smaller wall thickness must be produced, i.e. bent and welded, and must then undergo one or more drawing processes, by which the outside diameter and the wall thickness of the pipe is reduced. If several drawing processes are necessary to achieve the desired pipe, generally a heat treatment of the pipe is necessary between the individual drawing processes. By the additional working steps in the production of a pipe, for so-called “drawn” pipes, the price is much higher than for simply welded pipes. The additional cost for “drawn” pipes being up to 30%.

In the prior art, the production of the initially described rotationally symmetrical component from a pipe requires the following steps shown in FIGS. 1A-1D:

Producing a welded pipe with an outside diameter D₁ and a wall thickness d₁,

Producing a pipe with an outside diameter D₂<D₁ and a wall thickness d₂<d₁ by one or more drawing processes,

Sinking an area, preferably the middle area, of the pipe so that in this area the pipe has an outside diameter D_{M}<D₂ and a wall thickness d_{M}<d₁, and

Working of at least one area, preferably an end area, of the pipe by rotary swaging at room temperature so that in this area the pipe has an outside diameter D_{E}<D₁ and a wall thickness d_{E}>d₂.

### SUMMARY OF THE INVENTION

Therefore, an object of the invention is to devise a process for producing a rotationally symmetrical component from a pipe, which process can be carried out as simply and thus as economically as possible.

This object is achieved first of all by essentially a process with the following process steps:

Provide a pipe with a wall thickness which corresponds to the smallest wall thickness of the finished component,

Partial heating at least one area of the pipe,

Axial upsetting the heated area of the pipe and

Radial forging the heated area of the pipe.

The process of the invention can be carried out more easily and thus more economically by using a pipe with a wall thickness which corresponds to the smallest wall thickness of the finished component as the initial starting material. Within the framework of this invention, only the wall thickness of an area of the component with a certain length is ever considered. If, for example, the edge of the component has a short shoulder which has a small wall thickness, this should not be understood as the smallest wall thickness of the component. Generally, the component will have its smallest wall thickness roughly in the middle area, however, the area of the smallest wall thickness need not be exactly in the middle of the component. In the process of the invention, the step of sinking of an area, especially the middle area of the pipe, which is generally necessary in the prior art, is eliminated. If the shaft to be produced from the pipe is to be the drive shaft of a motor vehicle, only the two end areas need be worked, but not the middle area. The material volume necessary for producing an end area with a large wall thickness, for which in the prior art a pipe with a greater wall thickness than the initial material is necessary, is made available in the production of the rotationally symmetrical component according to the process of the invention by axial upsetting of the heated area of the pipe.

It is particularly advantageous if a welded pipe, which has not been redrawn, is used as the pipe. In this way, as stated above, the production costs for the initial material, i.e. the pipe, can be significantly reduced. The process of the invention can be advantageously developed by carrying out axial upsetting and radial forging of the heated area of the pipe in a clamp, preferably in one step. When the pipe need not be re-clamped from one machine to another in the individual working steps, the production times are shorter for the rotationally symmetrical component; this likewise benefits production costs.

In one alternative process for producing a rotationally symmetrical component from a pipe, the process has the following process steps:

Providing a welded pipe which has not been redrawn and with a relatively large wall thickness and

Working of at least one area of the pipe by means of rotary swaging at room temperature.

In the process according to the second embodiment of the invention, the production costs are reduced by using as the initial material a pipe which is simply welded, but which has not been redrawn. The material volume necessary to achieve an edge area of the pipe with a relatively large wall thickness is made available in this process by bending the pipe from sheet metal or steel strip with great thickness. Advantageously, in the process according to this second embodiment of the invention the wall thickness of the pipe corresponds to the smallest wall thickness of the finished component.

In addition, the invention relates to a rotationally symmetrical component, especially a hollow monoblock shaft, with an outside diameter which varies over the entire length of the component and/or a varying wall thickness, the component having been produced from a pipe with a constant outside diameter and a constant wall thickness according to the process of the invention.

In particular, there is a plurality of possibilities for embodying and developing the inventive process and the rotationally symmetrical component of the invention. In this regard, reference is made to the following detailed description of one embodiment in conjunction with the drawings.

### BRIEF DESCRIPTION OF THE DRAWINGS

FIGS. 1A-1D illustrate a shaft, shown in different production stages in a process known in the prior art, and

FIGS. 2A-2C illustrate a shaft, shown in different production stages in one preferred embodiment of the process of the invention.

### DETAILED DESCRIPTION OF THE INVENTION

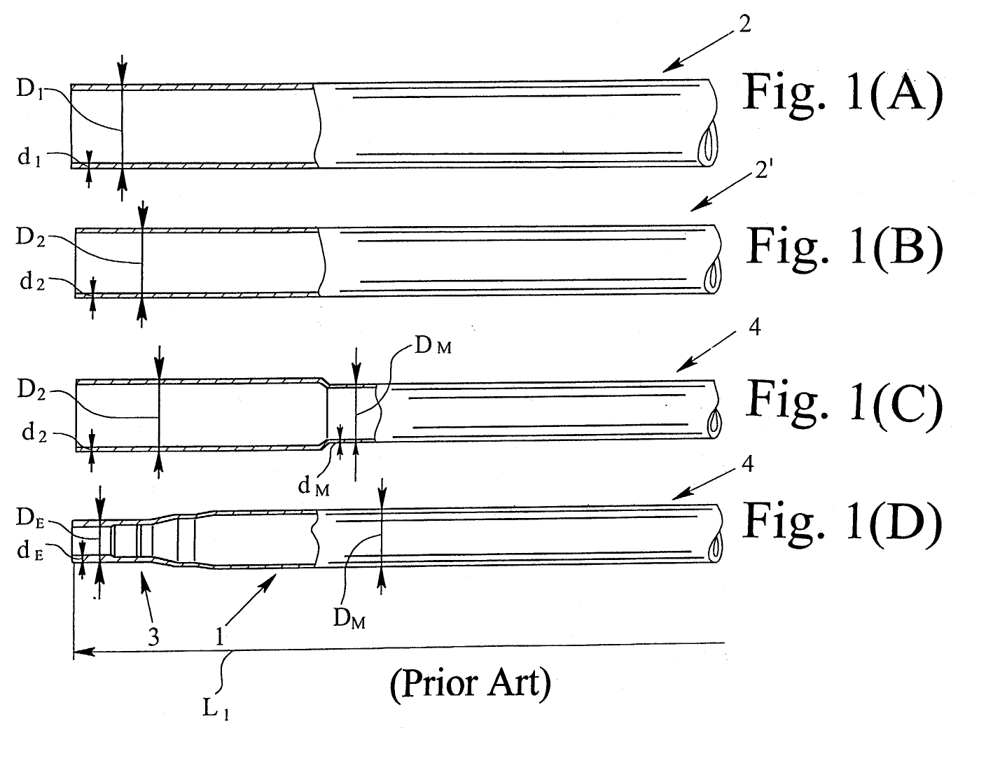

FIGS. 1A-1D schematically show the production sequence in the manufacture of a shaft 1 with an outside diameter D which varies over the entire length and a varying wall thickness d according to the process known from the prior art, proceeding from a pipe 2. Of the four production steps shown overall, the first two production steps (FIGS. 1A and 1B) relate to the production of the pipe 2, while the last two production steps (FIGS. 1C and 1D) relate to production of the shaft 1 from the pipe 2.

FIG. 1A shows a simply welded pipe 2 with an outside diameter D₁ and a wall thickness d₁. The wall thickness d₁ corresponds to the thickness of the sheet metal or steel strip from which the pipe 2 has been bent. FIG. 1B shows the pipe 2′ after it has been drawn through a drawing die or drawing ring. By drawing the pipe 2, it has an outside diameter D₂<D₁ and a wall thickness d₂<d₁. This pipe 2′ is dimensioned such that from the pipe a shaft 1 with an end area 3 with the desired outside diameter D_{E} and the desired wall thickness d_{E} can be produced by rotary swaging. At the same time, the pipe 2′ however has an outside diameter D₂ and a wall thickness d₂ which are each larger than the outside diameter D_{M} and the wall thickness d_{M} of the middle area 4 of the shaft 1. Thus, in the production of the shaft 1 from the pipe 2′, it is first necessary to sink the middle area 4 in order to achieve the desired outside diameter D_{M} and the desired wall thickness d_{M}. For this reason a mandrel which is not shown here, with the corresponding outside diameter, is inserted into the pipe 2′ and then the pipe 2′ is worked by peening from the outside in its middle area 4 (compare FIG. 1C). Finally, for the shaft 1 the end area 3 is worked using the rotary swaging process so that the end area 3 has the desired outside diameter and wall thickness variation shown in FIG. 1D.

Producing a shaft 1 according to the above described process is especially complex and costly due to the fact that first the pipe 2′ must be produced in several process steps, specifically besides the actual bending and welding in addition it must undergo one or more drawing processes and associated therewith in addition one or more heat treatments. Then to produce the shaft 1 from the pipe 2′ both the middle area 4 and also the end area 3 must be worked, specifically the middle area 4 must be formed by means of sinking and the end area 3 by means of rotary swaging. The rotary swaging process at room temperature moreover has the disadvantage that due to result of strain hardening only relatively low degrees of working can be achieved.

The pipe 2 shown in FIGS. 1A-1D and the illustrated shaft 1 has for example the following outside diameter D and wall thickness d in the individual process steps:

D₁=60 mm, d₁=4.5 mm

D₂=50 mm, d₂=4.0 mm

D_{M}=40 mm, d_{M}=3.5 mm

D_{E}=26 mm, d_{E}=8.0 mm

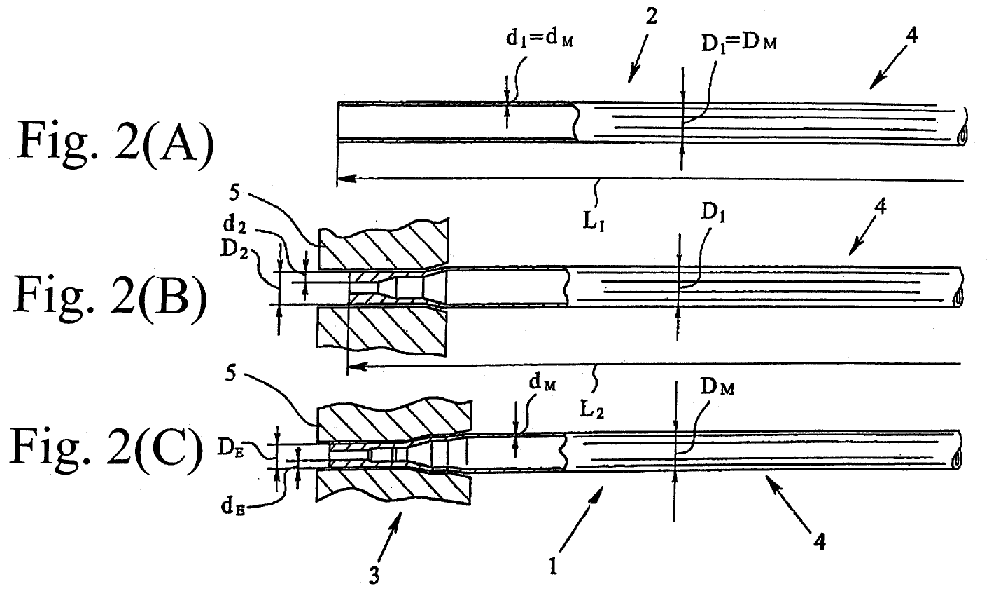

FIGS. 2A-2C illustrate one embodiment of the process of the invention for producing a shaft 1 using three production steps. The first production step (FIG. 2A) corresponds to the first production step (FIG. 1A) in the process known from the prior art, it shows specifically a simply welded pipe 2 with an outside diameter D₁ and a wall thickness d₁. First of all, it is significant that the wall thickness d₁ of the pipe 2 corresponds to the wall thickness d_{M} of the middle area 4 of the finished shaft 1. In addition, the outside diameter D₁ of the pipe corresponds to the outside diameter D_{M} of the middle area 4 of the shaft 1 so that the middle area 4 of the pipe 2 or of the shaft 1 need not be worked.

Another advantage of the process of the invention is that a simple welded pipe 2, which has not been redrawn, can be used as the pipe 2. In this way, in the process of the invention one working step in the production of the pipe 2, specifically the drawing of the pipe 2, can be saved.

FIG. 2B illustrates that the pipe 2, which has been partially heated in the end area 3, is axially upset so that the pipe 2 has a total length L₂<L₁. The axial upsetting of the pipe 2 leads to an increased wall thickness in the end area 3. In addition to axial upsetting, the heated area of the pipe 2, i.e. the end area 3, is worked by radial forging with a forging tool 5, by which the desired outside diameter DE is achieved. One multistage change in the outside diameter and wall thickness in the end area 3 is achieved by several radial forging processes. In the first intermediate step, the end area 3 has an outside diameter D₂<D₁.

To achieve the desired variation of the outside diameter in the end area 3, during the axial upsetting and radial forging of the heated area a mandrel is inserted into the pipe 2. By choosing the outside diameter of the mandrel, then the desired wall thickness d_{E} of the shaft 1 is fixed. Because the pipe 2 is partially heated, considerably few or no strain hardening processes occur, by which a greater degree of working is possible.

The pipe 2 shown in FIGS. 2A-2C has, for example, the following outside diameters D and wall thicknesses d:

D₁=D_{M}=40 mm, d₁=d_{M}=3.5 mm

D₂=30 mm, d₂=8.0 mm

D_{E}=26 mm, d_{E}=6.0 mm.

While various embodiments in accordance with the present invention have been shown and described, it is understood that the invention is not limited thereto. These embodiments may be changed, modified and further applied by those skilled in the art.

Therefore, this invention is not limited to the details shown and described previously but also includes all such changes and modifications which are encompassed by the appended claims.

What is claimed is:

1. A process for producing a rotationally symmetrical component from a pipe, wherein the pipe has a constant outside diameter and a constant wall thickness, and the rotationally symmetrical component has an outside diameter of at least one portion of the length of the component which deviates from the constant outside diameter of the pipe and a wall thickness which deviates from the constant wall thickness of the pipe, comprising the steps of:
selecting a pipe having a constant wall thickness which corresponds to the smallest wall thickness of the finished rotationally symmetrical component,
partially heating at least one portion of the length of the pipe,
axial upsetting the heated portion of the pipe, and
radial forging the heated portion of the pipe to form the at least one portion of the rotationally symmetrical component.

2. The process as set forth in claim 1, wherein a welded pipe which has not been redrawn is used as the pipe.

3. The process as set forth in claim 1, wherein axial upsetting and radial forging of the heated portion of the pipe takes place while the pipe is clamped.

4. The process as set forth in claim 3, wherein axial upsetting and radial forging of the heated portion of the pipe is performed in one working step.

5. The process as set forth in claim 1, wherein is inserted at least into the heated portion of the pipe during the axial upsetting and during radial forging of the heated portion of the pipe a mandrel.

6. The process as set forth in claim 1, wherein the pipe has an outside diameter which corresponds to the largest outside diameter of the rotationally symmetrical component.

7. A process for producing a rotationally symmetrical component from a pipe, wherein the pipe has a constant outside diameter and a constant wall thickness, and the rotationally symmetrical component has an outside diameter on at least one portion of the length of the component which deviates from the constant outside diameter of the pipe and a wall thickness which deviates from the constant wall thickness of the pipe, comprising the steps of:
selecting a welded pipe that has not been redrawn having a particular wall thickness, and
working at least one portion of the pipe by means of rotary swaging at room temperature to form the at least one portion of the rotationally symmetrical component.

8. The process as set forth in claim 7, wherein the wall thickness of the pipe corresponds to the smallest wall thickness of the finished rotationally symmetrical component.

9. A rotationally symmetrical component having an outside diameter and a wall thickness which vary over the length of the component produced according to the process of claim 1.

10. A rotationally symmetrical component as set forth in claim 9, wherein the component is a hollow monoblock shaft.

11. A rotationally symmetrical component as set forth in claim 9, wherein the at least one portion of the component is an end portion which has a smaller outside diameter and a greater wall thickness than a middle portion of the component.

12. A rotationally symmetrical component as set forth in claim 11, wherein the middle portion of the component has the same outside diameter and the same wall thickness as the pipe.

13. A rotationally symmetrical component having an outside diameter and a wall thickness which vary over the length of the component produced according to the process of claim 7.

14. A rotationally symmetrical component as set forth in claim 13, wherein the component is a hollow monoblock shaft.

15. A rotationally symmetrical component as set forth in claim 13, wherein the at least one portion of the component is an end portion which has a smaller outside diameter and a greater wall thickness than a middle portion of the component.

16. A rotationally symmetrical component as set forth in claim 15, wherein the middle portion of the component has the same outside diameter and the same wall thickness as the pipe.
